(19) United States
(12) Patent Application Publication
(10) Pub. No.: US 2013/0191238 A1
(43) Pub. Date: Jul. 25, 2013

(54) AUTOMATED NEGOTIATION

(71) Applicants: Mehmet Kivanc Ozonat, San Jose, CA (US); Sharad Singhal, Belmont, CA (US)

(72) Inventors: Mehmet Kivanc Ozonat, San Jose, CA (US); Sharad Singhal, Belmont, CA (US)

(73) Assignee: Hewlett-Packard Development Company, L.P., Houston, TX (US)

(21) Appl. No.: 13/877,395

(22) PCT Filed: Oct. 8, 2010
(86) PCT No.: PCT/US10/52089

§ 371 Date: Apr. 2, 2013

(51) Int. Cl. G06Q 30/06

(52) U.S. Cl. CPC G06Q 30/06
USPC 705/26.4

(57) ABSTRACT

An agreement is negotiated on behalf of a first party. A region (32) of acceptable terms for the first party is determined. A plurality of offers (15) from a second party is analyzed to detect values for terms that indicate a change in strategy used by the second party when making the plurality of offers (15). A region (57) of acceptable terms for the second party is estimated based on detected locations of changes in strategy. Terms for a new offer (14) from a first party to the second party are provided. The terms of the new offer (14) are within the region (32) of acceptable terms for the first party within a threshold distance from the estimated region (57) of acceptable terms for the second party.

### BACKGROUND

Shoppers increasingly make purchases over the Internet. Sellers use servers to make goods and services available for sale over the Internet.

### BRIEF DESCRIPTION OF DRAWINGS

FIG. 1 is a block diagram showing an example of a negotiating system within a server that negotiates with a buyer in accordance with one disclosed implementation.

FIG. 2 shows an example of a seller's region of acceptable terms for sale of a good in accordance with one disclosed implementation.

FIG. 3 shows an example of an offer history for a buyer in a negotiation in accordance with one disclosed implementation.

FIG. 4 shows an example of an estimated buyer's region of acceptable terms superimposed on the offer history shown in FIG. 3, in accordance with one disclosed implementation.

FIG. 5 shows an example of the results of calculation of a threshold distance between the seller's region of acceptable terms shown in FIG. 2 and the estimated buyer's region of acceptable terms shown in FIG. 4 in accordance with one disclosed implementation.

FIG. 6 is an example flowchart illustrating a negotiation process in accordance with one disclosed implementation.

### DETAILED DESCRIPTION

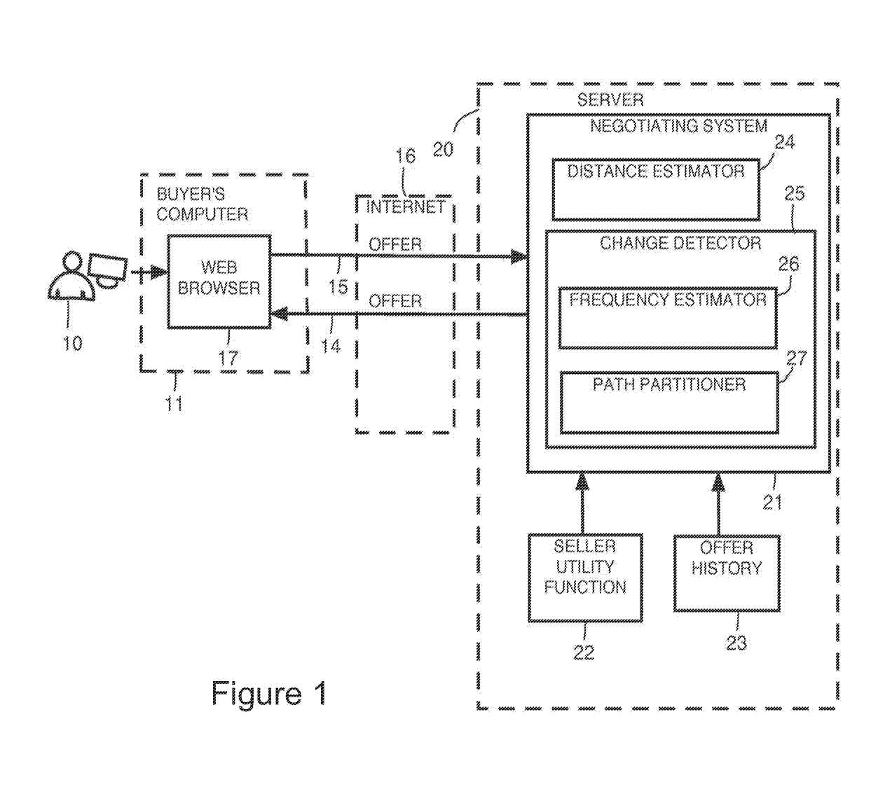

FIG. 1 is a block diagram showing a negotiating system 21 within a server 20. Negotiating system 21 performs a negotiation with a buyer 10 utilizing a web browser 17 within a computer 11 to communicate with negotiating system 21 through the Internet 16. During a negotiation, negotiating system 21 receives one or more offers from buyer 10, as represented in FIG. 1 by an arrow 15, and potentially sends one or more offers back to buyer 10, as represented by an arrow 14. Negotiating system may also accept an offer made by buyer 10. Negotiating system 21 includes a distance estimator 24 and a change detector 25. The change detector 25 includes a frequency estimator 26 and a path partitioner 27.

In order to prepare a response to an offer received from buyer 10, negotiating system 21 consults with a seller's utility function 22 and with offer history 23. Offer history 23 includes an offer history for buyer 10 and can additionally include an offer history for previous negotiations with the same or other buyers and even potential buyers who were part of negotiations that did not end up in a purchase.

The seller's region of acceptable terms is defined by a utility function 22 that indicates, for a plurality of factors, combinations of terms that would be acceptable to a seller represented by negotiation system 21.

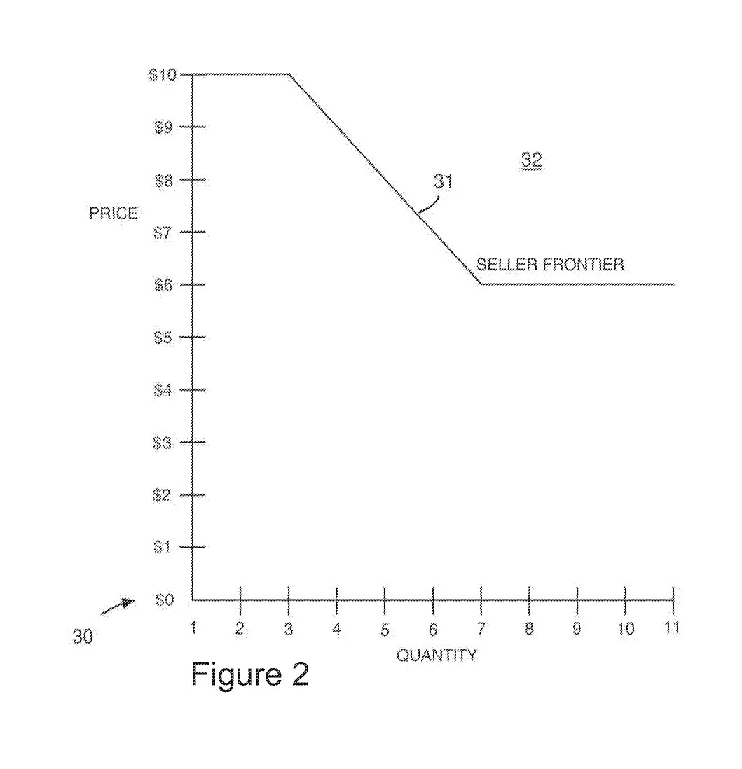

For example, consider a seller utility function 22 based on the consideration of only two terms: price and quantity. For quantities of one, two or three, the seller is willing to sell a product for a minimum price of ten dollars. The product is, for example, a good or a service. For a quantity of four products, the seller is willing to sell each product for a minimum price of nine dollars. For a quantity of five products, the seller is willing to sell each product for a minimum price of eight dollars. For a quantity of six products, the seller is willing to sell each product for a minimum price of seven dollars. For quantities of seven or more, the seller is willing to sell each product for a minimum price of six dollars. The region of acceptable terms defined by the above-described utility function is illustrated by FIG. 2. In FIG. 2, a graph 30 has a line 31 that demarks a frontier of a region of acceptable terms 32 that would be acceptable to the seller. In the example illustrated by FIG. 2, any offers on or above frontier line 31 are within region of acceptable terms 32 and thus are acceptable to the seller. That is, the frontier represented by 31 demarks region of acceptable terms 32 and thus indicates which combinations of terms for an agreement would be acceptable to the seller.

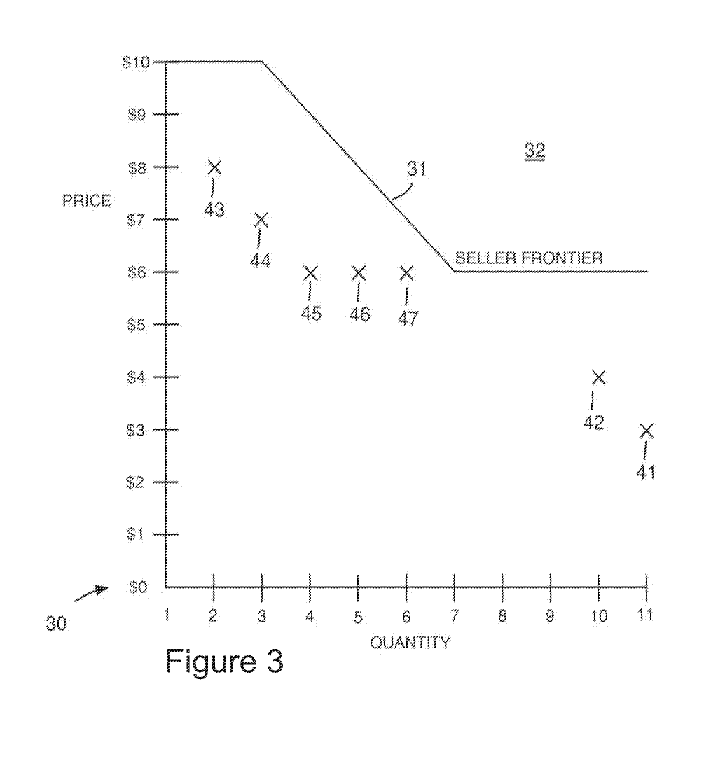

FIG. 3 illustrates offers made in a negotiation to purchase the product. For example, in the course of a negotiation, a buyer made an offer 41 to purchase eleven products at a price per product of $3, followed by an offer 42 to purchase ten products at a price per product of $4, an offer 43 to purchase two products at a price per product of $8, an offer 44 to purchase three products at a price per product of $7, an offer 45 to purchase four products at a price per product of $6, an offer 46 to purchase five products at a price per product of $6 and an offer 47 to purchase six products at a price per product of $6.

During the course of the negotiation, frequency estimator 26 detects the difference between term values for consecutive offers from a buyer. That is, offers differ based on the values of the terms for each offer. For example, between offer 41 and offer 42 there is a difference in each of the terms. Offer 41 was for eleven products and offer 42 was for ten products; therefore, between offer 41 and offer 42 there is a difference of one (1) in the product. Offer 41 was for $3 per product and offer 42 was for $4 per product; therefore, between offer 41 and offer 42 there is a difference of minus one (−1) in the price term. The difference in the offers can thus be represented by (1,−1) indicating a difference of one in the product term and a difference of minus one in the price term. Offer 45 and offer 46 have difference of (−1,0) indicating a difference of minus one in the product term and no difference in the price term. Frequency estimator 26 measures the difference in values of terms between offers to determine the frequency of steps for the terms. After all differences are computed, their frequencies of occurrence are estimated. For example, consider a repository of 100 buyers and 10 rounds per buyer. We have 100×10=1000 differences between the consecutive offers. Assume the difference (−1,1) occurred 20 times. So, the step frequency of (−1,1) is 20/1000=0.05.

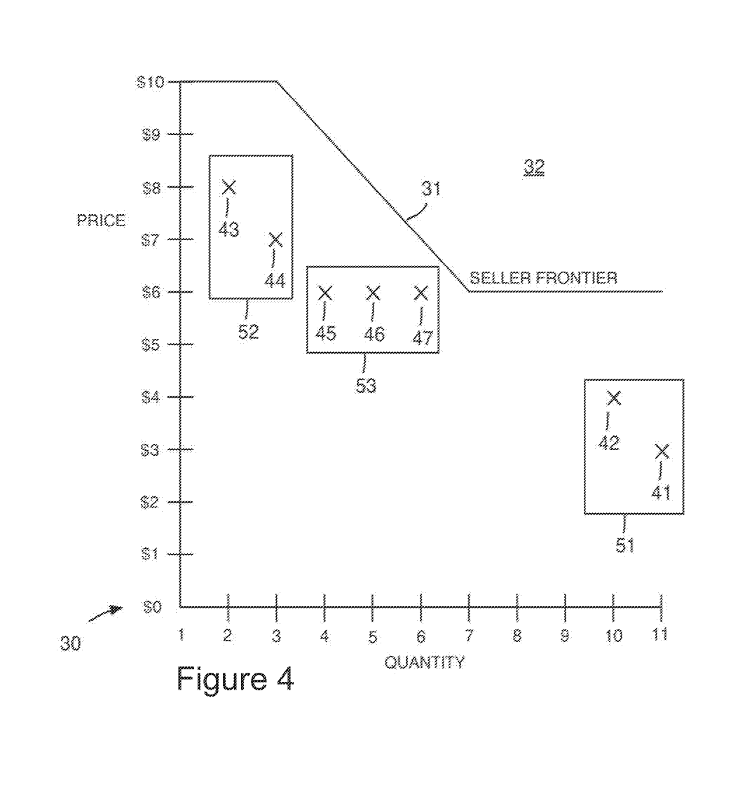

Path partitioner 27 uses the step frequencies discovered by frequency estimator 26 to determine at which offers, the terms indicate changes (if any) occurred in the buyer's strategy. This identifies purchase strategies of the buyer. In FIG. 3, the strategies appear as offer paths. For example, for the negotiation illustrated by FIG. 3, three different strategies/offer paths might be detected, as illustrated by FIG. 4. A first strategy (offer path) 51 was detected for offer 41 and offer 42. A second strategy 52 was detected for offer 43 and offer 44. A third strategy 53 was detected for offer 45, offer 46 and offer 47.

One method to partition the sequence of offers into segments—called strategies or offer paths—is based on step entropies. What is meant by step entropy is the negative logarithm of the step frequency, as the step frequency is calculated above. The information-theoretic entropy of each step is computed based on the frequency of the step. Then, the entire sequence is partitioned into one or more segments (also called offer paths or strategies) to minimize the entropy cost of the entire sequence. The entropy cost of a segment is the sum of the entropies of the steps within the offer path that form the segment. The entropy cost of the entire sequence of offers is the sum of two costs. The first cost is a sum of the entropies for all the segments. The second cost monotonically increases with the number of segments. For example, the second cost is equal to the number of segments. Alternatively, any function that monotonically increases with the number of segments can be used.

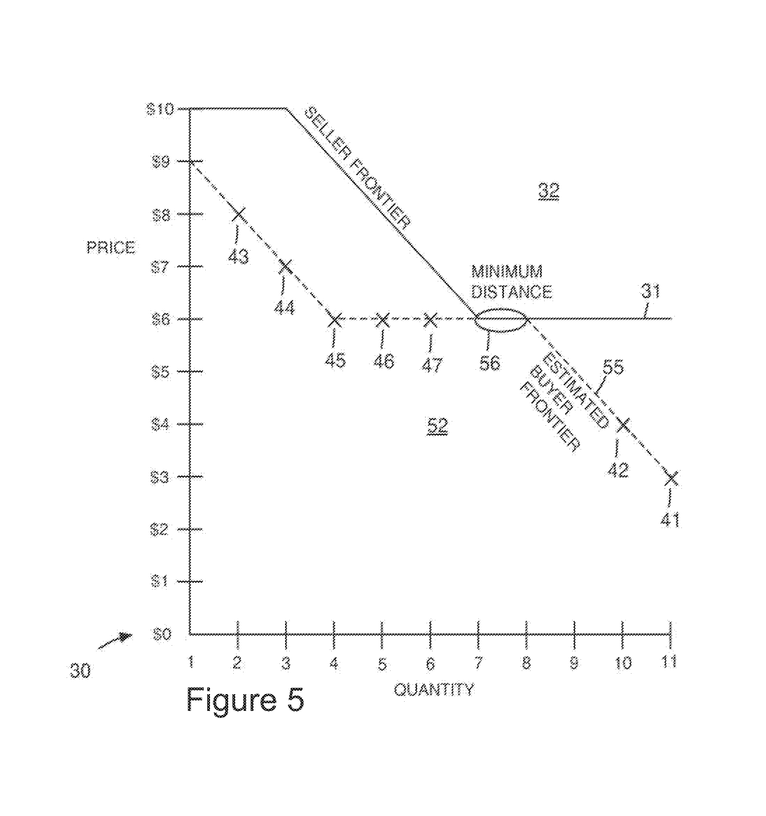

Once the individual strategies (i.e., paths) are detected, distance estimator 24 estimates the distance from each strategy to the seller's acceptable region of offers. This can be done by, for example, by estimating the most likely future trajectory of the buyer given each path, where the likelihood of a trajectory can be estimated based on the step frequencies. The location of a buyer frontier defining an estimated buyer's region of acceptable terms 57 is shown in FIG. 5. Estimated buyer's region of acceptable terms 57 indicates combinations of terms for selling the products that are estimated to be acceptable to the buyer. Once the location of estimated buyer's region of acceptable terms 57 is estimated by estimating future trajectories for each path, it is possible to determine locations where the distance between buyer's region of acceptable terms 57 and the seller's region of acceptable terms 32 is within a threshold value. For example, within the threshold value can occur wherever there is a minimum distance between the seller's region of acceptable terms and the estimated buyer's region of acceptable terms 57.

For example, distance can be quantified by computing a value for likelihood of possible future trajectories based on step frequencies, and then assigning a value for distance that is equal to a ratio of one over the value for likelihood of possible future trajectories. FIG. 5 illustrates a result of determining locations where the distance between buyer's region of acceptable terms 57 and the seller's region of acceptable terms 32 is within a threshold value.

Once the individual strategies are detected, distance estimator 24 estimates the location of a buyer frontier defining an estimated buyer's region of acceptable terms 57, shown in FIG. 5. Estimated buyer's region of acceptable terms 57 indicates which combination of terms for selling the products are estimated to be acceptable to the buyer. Once the location of estimated buyer's region of acceptable terms 57 is estimated, it is possible to determine locations where the distance between buyer's region of acceptable terms 57 and the seller's region of acceptable terms 32 is at a minimum value or within another threshold value. This is illustrated in FIG. 5.

In FIG. 5, the identified first strategy 51, second strategy 52 and third strategy 53 have been used to locate an estimated buyer frontier 55. Negotiation system 21 thus infers that all points on or below buyer frontier line 55 are acceptable to the buyer and are within the estimated buyer's region of acceptable terms 57. The seller frontier 31 intersects with estimated buyer frontier 55 at offer terms indicated by oval 56. Oval 56 represents offer terms where the distance between the buyer's estimated region of acceptable terms and the seller's region of acceptable terms is within a threshold value. For example, the buyer's estimated region of acceptable terms is within a threshold distance of the seller's region of acceptable terms when seller frontier 31 and estimated buyer frontier 55 overlap. If there is no overlap, the buyer's estimated region of acceptable terms is within a threshold distance from the seller's region of acceptable terms wherever terms represented by seller frontier 31 are closest to terms represented by estimated buyer frontier 55.

Given the offer history and the seller region of acceptable terms represented in FIG. 5, negotiation system 21 will make a next offer from offer terms within oval 56 where the distance between the buyer's estimated region of acceptable terms and the seller's region of acceptable terms is at a minimum value or within another threshold value. For example, offer system 21 will offer to sell 7 products at a price per product of $6 and/or will offer to sell 8 products at a price per product of $6.

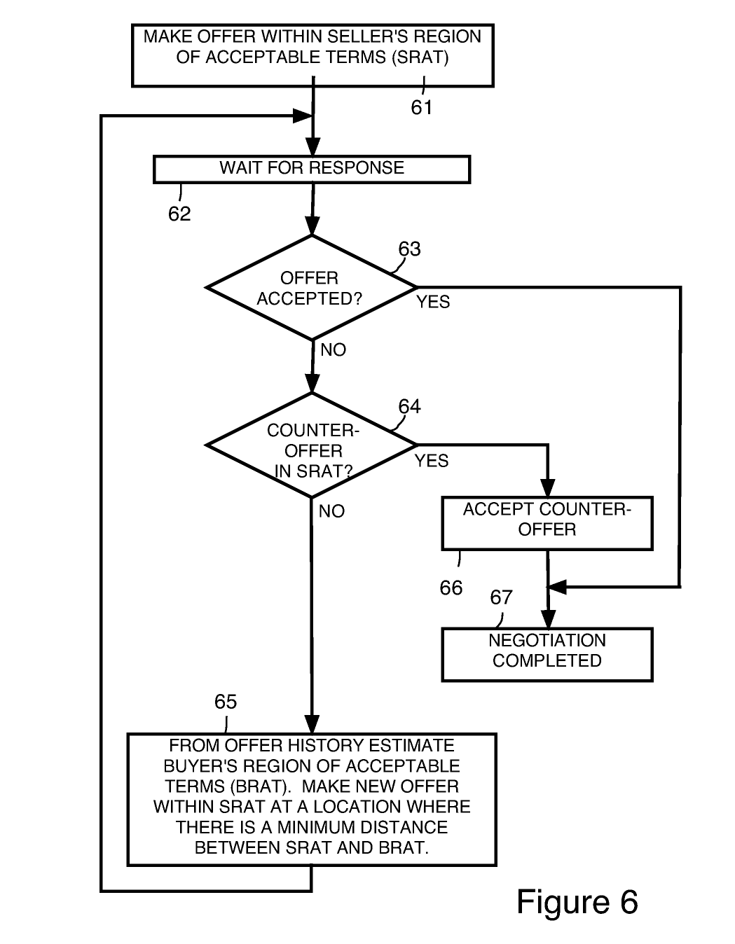

FIG. 6 is a flowchart illustrating a negotiation conducted by negotiation system 21. In a block 61, negotiation system 20 makes an offer containing values for terms that are within the seller region of acceptable terms (SRAT) for the products. In a block 62, negotiation system 21 waits for a response.

Once a response is received, in a block 63, negotiation system 21 checks whether the offer has been accepted. If not, in a block 64, negotiation system 21 checks whether a counter-offer given by the buyer contains values for terms within the seller region of acceptable terms.

If in block 64 the counter-offer does not contain values for terms within the seller region of acceptable terms, in a block 65 negotiation system 21 utilizes change detector 25 and distance estimator 24 to prepare a new offer. Particularly, change detector 25 and distance estimator 24 are used, as described above, to estimate a buyer region of acceptable terms. Negotiation system 21 then can determine offer terms that are within a threshold distance—for example, they are at a minimum distance—between the seller region of acceptable terms and the estimated seller region of acceptable terms. The threshold distance can encompass offer terms where the seller region of acceptable terms and the estimated seller region of acceptable terms overlap. The new offer contains values for terms within the seller region of acceptable terms that are within a threshold distance from the estimated seller region of acceptable terms. After making the new offer, negotiation system 21 returns to block 62 to way for a response.

When in block 63 negotiation system 21 recognizes that the latest offer has been accepted, in a block 67 the negotiation is completed.

When in block 64 negotiation system 21 recognizes that counter-offer contains a combination of values for terms that is within the seller region of acceptable terms, in a block 66 negotiation system 21 accepts the counter-offer and in block 67 the negotiation is completed.

In the examples given above, the automated negotiation is performed on behalf of a seller where the seller's utility function is known and a buyer's utility function is estimated based on the buyer's offer history and in some cases others buyer's offer history. The automated negotiation also can be performed on behalf of a buyer where the buyer's utility function is known, and a seller's utility function is estimated based on the seller's offer history. In this case, a new offer will contain values for terms within the buyer's region of acceptable terms defined by the buyer's utility function within a threshold distance from an estimated seller's region of acceptable terms.

Additionally, in the examples above, the automated negotiation was illustrated in the negotiation of an agreement to purchase a product, such as a good or service. However, the automated negotiation can be performed in any type of agreement where a first party and a second party are negotiating terms.

Also, in the examples above, automated negotiation was illustrated using utility functions based on consideration of two terms. However, the automated negotiation can also use utility functions based on consideration of one, three, four or more terms.

The methods, techniques, systems, and apparatuses described herein may be implemented in digital electronic circuitry or computer hardware, for example, by executing instructions stored in computer-readable storage media.

Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order, in some implementations, individual operations may be rearranged in a different order and/or eliminated and the desired results still may be achieved. Similarly, components in the disclosed systems may be combined in a different manner and/or replaced or supplemented by other components and the desired results still may be achieved.

We claim:

1. A negotiation system (21) used to provide automated negotiation, the negotiation system (21) conducting the negotiation on behalf of a first party, the negotiation system (21) comprising:
a change detector (25) that analyzes a plurality of offers (15) from a second party to detect values for terms that indicate a change in strategy used by the second party when making the plurality of offers (15); and,
a distance estimator (24) that estimates, based on changes in offer strategy detected by the change detector (25), a region (57) of acceptable terms for the second party and provides terms for a new offer (14) from the first party to the second party, the terms of the new offer (14) being within a region (32) of acceptable terms of the first party within a threshold distance from the estimated region (57) of acceptable terms for the second party.

2. A negotiation system (21) as in claim 1 wherein the region (32) of acceptable terms for the first party defines which combination of terms will be acceptable to the first party.

3. A negotiation system (21) as in claim 1 wherein the negotiation is for the purchase of a good or a service.

4. A negotiation system (21) as in claim 1 wherein the change detector (25) comprises:
a frequency estimator (26) that detects differences between term values for offers (15) from the second party; and,
a path partitioner (27) that detects where there occurs a change in offer strategy used by the second party when making the plurality of offers (15).

5. A negotiation system (21) as in claim 1 wherein terms for the new offer (14) include at least one of the following:
a value for price per product;
a value for delivery time;
a value for number of products.

6. A negotiation system (21) as in claim 1 wherein within the threshold distance occurs where there is a minimum distance between the region (32) of acceptable terms of the first party and the estimated region (57) of acceptable terms for the second party.

7. A negotiation system (21) as in claim 1 wherein the first party is a seller and the second party is a buyer.

8. A computer implemented method for negotiating an agreement comprising:
determining a region (32) of acceptable terms for a first party;
analyzing a plurality of offers (15) from a second party to detect values for terms that indicate a change in strategy used by the second party when making the plurality of offers (15);
estimating a region (57) of acceptable terms for the second party based on detected values for terms that indicate a change in strategy; and,
providing terms for a new offer (14) from a first party to the second party, the terms of the new offer (14) being within the region (32) of acceptable terms for the first party within a threshold distance from the estimated region (57) of acceptable terms for the second party.

9. A computer implemented method as in claim 8 wherein determining a region (32) of acceptable terms for the first party includes defining which combination of terms will be acceptable to the first party.

10. A computer implemented method as in claim 8 wherein estimating a region (57) of acceptable terms for the second party includes estimating which combination of terms will be acceptable to the second party.

11. A computer implemented method as in claim 8 wherein values for terms that indicate a change in strategy are detected by partitioning a sequence of offers into segments based on entropy cost, where the entropy cost includes a cost that monotonically increases with a number of segments.

12. A computer implemented method as in claim 8 wherein values for terms that indicate a change in strategy are detected by partitioning offer paths (51,52,53) based on step frequencies.

13. Tangible computer readable medium having embodied thereon a computer program for instructing a computer to perform a method for negotiating an agreement comprising:
analyzing a plurality of offers (15) from a second party to detect values for terms that indicate a change in strategy used by the second party when making the plurality of offers (15);
estimating a region (57) of acceptable terms for the second party based on detected values for terms that indicate a change in strategy; and,
providing terms for a new offer (14) from a first party to the second party, the terms of the new offer (14) being within a region (32) of acceptable terms for the first party within a threshold distance from the estimated region (57) of acceptable terms for the second party.

14. Tangible computer readable medium as in claim 13 wherein estimating a region (57) of acceptable terms for the second party includes estimating which combination of terms will be acceptable to the second party.

15. Tangible computer readable medium as in claim 13 wherein values for terms that indicate a change in strategy are detected by partitioning offer paths (51,52,53) based on step frequencies.
